(19) United States
(12) Patent Application Publication
(10) Pub. No.: US 2019/0134548 A1
(43) Pub. Date: May 9, 2019

(54) BLOWING UNIT FOR AIR CLEANER AND AIR CLEANER INCLUDING THE SAME

(71) Applicant: WINIX INC., Siheung-si (KR)

(72) Inventor: Chul Min YOON, Siheung-si (KR)

(21) Appl. No.: 15/992,724

(22) Filed: May 30, 2018

(30) Foreign Application Priority Data
May 31, 2017 (KR) 10-2017-0067428
May 29, 2018 (KR) 10-2018-0060889

(51) Int. Cl. B01D 46/00; B01D 46/10; F24F 1/00; F24F 13/20; F24F 13/28; F04D 13/06; F04D 15/00; F04D 17/16; F04D 27/00; F04D 29/42

(52) U.S. Cl. CPC B01D 46/0041; B01D 46/10; F24F 1/00; F24F 13/20; F24F 13/28; B01D 2279/50; F04D 15/0022; F04D 17/16; F04D 27/002; F04D 29/4213; F04D 29/4246; F04D 13/06

(57) ABSTRACT

Provided is an air cleaner including a fan member configured to take air in from both sides of an axial direction thereof and discharge the air, and a casing member in which the fan member is rotatably disposed, a plurality of inlets through which the air is taken in from both the sides of the axial direction of the fan member is formed, and a plurality of outlets through which the air is discharged in a plurality of directions is formed, wherein the plurality of outlets may include a first outlet configured to discharge the air toward an upper side of the fan member, and a second outlet configured to discharge the air in a direction perpendicular to the axial direction of the fan member.

### BACKGROUND

### Field

One or more example embodiments relate to a blowing unit for an air cleaner and an air cleaner including the same, and more particularly, to a blowing unit for an air cleaner and an air cleaner including the same, the blowing unit that may take air in through a plurality of inlets and discharge the air through a plurality of outlets.

### Description of Related Art

An air cleaner is a device that takes contaminated external air in, passes the air through a filter assembly to remove harmful substances such as fine dust, and discharges purified air through an outlet.

It is important for the air cleaner that purifies indoor air to take contaminated air in a predetermined space in a short time, filter the air through a filter thereof, and circulate the purified air quickly.

An existing air cleaner is provided in a two-dimensional air flow structure of a front-in top-out type, and thus has a relatively low air circulation rate. For example, it takes about 1 hour to purify air of 30 cubic meters (m³).

Thus, development of an air cleaner that may solve such an issue is needed.

For example, Korean Patent Application Publication No. KR20100098170 discloses “Air cleaner”.

The above description has been possessed or acquired by the inventor(s) in the course of conceiving the present invention and is not necessarily an art publicly known before filing the present application.

### BRIEF SUMMARY

[Technical Goals]

An aspect provides a blowing unit for an air cleaner and an air cleaner including the same that may combine 2-way-in and 3-way-out, thereby reducing a volume thereof, reducing an energy consumption, and operating at a high efficiency.

An aspect provides a blowing unit for an air cleaner and an air cleaner including the same that may maximize intake and discharge areas, thereby improving the product efficiency, minimizing a loss of air volume, and reducing noise.

An aspect provides a blowing unit for an air cleaner and an air cleaner including the same that may smoothly circulate an air flow of an indoor space and take in or purify contaminated air in a predetermined space in a relatively short time when compared to a single-out type air cleaner.

An aspect provides a blowing unit for an air cleaner and an air cleaner including the same that may form a three-dimensional air flow, thereby improving an air circulation rate by about 30%.

An aspect provides a blowing unit for an air cleaner and an air cleaner including the same that may be provided in a structure that may be easily assembled or disassembled, thereby improving the manufacturing convenience and facilitating the maintenance.

### Technical Solutions

According to an aspect, there is provided a blowing unit for an air cleaner, the blowing unit including a fan member configured to take air in from both sides of an axial direction thereof and discharge the air, and a casing member in which the fan member is rotatably disposed, a plurality of inlets through which the air is taken in from both the sides of the axial direction of the fan member is formed, and a plurality of outlets through which the air is discharged in a plurality of directions is formed, wherein the plurality of outlets may include a first outlet configured to discharge the air toward an upper side of the fan member, and a second outlet configured to discharge the air in a direction perpendicular to the axial direction of the fan member.

The plurality of outlets may further include a third outlet disposed to face the second outlet in the casing member, the third outlet configured to discharge the air in another direction perpendicular to the axial direction of the fan member, wherein the first outlet, the second outlet and the third outlet may be configured to discharge the air in different directions from an upper portion of the fan member.

A first discharge direction of the air through the first outlet may be orthogonal to a second discharge direction of the air through the second outlet, and the first discharge direction of the air through the first outlet and the second discharge direction of the air through the second outlet may be orthogonal to an intake direction of the air through a plurality of inlets.

The casing member may be formed to be branched toward the first outlet, the second outlet and the third outlet at an upper portion of one side of the fan member, and a plurality of blowing paths may be formed in the casing member from the upper portion of the one side of the fan member, wherein the plurality of blowing paths may include a first blowing path extending from the upper portion of the one side of the fan member toward the first outlet, a second blowing path extending from the upper portion of the one side of the fan member toward the second outlet, and a third blowing path extending from the upper portion of the one side of the fan member toward the third outlet.

A length of the second blowing path may be different from a length of the third blowing path, and a length of the first blowing path may be greater than the length of the second blowing path and the length of the third blowing path.

An angle of inclination of the first blowing path, an angle of inclination of the second blowing path and an angle of inclination of the third blowing path may be different from each other, and the angle of inclination of the first blowing path may be greater than the angle of inclination of the second blowing path and the angle of inclination of the third blowing path.

The blowing unit may further include a discharge flow rate adjusting member configured to separately adjust air flow rates of the first blowing path, the second blowing path and the third blowing path or cross-sectional areas of the first outlet, the second outlet and the third outlet.

The blowing unit may further include a separation member disposed to penetrate through a center of the fan member in the casing member, wherein the casing member may be divided into a pair of symmetric casings by the separation member such that blowing paths and the plurality of outlets may be divided separately in the casing member.

The blowing unit may further include a driving member configured to transmit power to the fan member, wherein the driving member may be inserted into the fan member and fixed to the separation member, and a half of the fan member may be received in one of the plurality of casings and a remaining half of the fan member may be received in the other one of the plurality of casings.

According to an aspect, there is provided an air cleaner including a blowing unit including a plurality of inlets configured to take air in and a plurality of outlets configured to discharge the air, a cover unit configured to cover a side in which the plurality of inlets of the blowing unit is formed, the cover unit including an intake hole formed to communicate with the plurality of inlets, and a filter unit disposed between the blowing unit and the cover unit, wherein the plurality of inlets may be disposed toward a front and a rear of the cover unit, and the plurality of outlets may be disposed toward a top and both sides of the cover unit.

The blowing unit may include a fan member configured to take air in from both sides of an axial direction thereof and discharge the air radially, a driving member configured to transmit driving power to the fan member, a casing member in which the fan member is rotatably disposed and the plurality of inlets and the plurality of outlets are formed, and a separation member disposed to penetrate through a center of the fan member, the separation member to which the fan member and the driving member are fixed, wherein passages of the air and the plurality of outlets in the casing member may be divided by the separation member.

### Effects

According to an example embodiment, a blowing unit for an air cleaner and an air cleaner including the same may combine 2-way-in and 3-way-out, thereby reducing a volume thereof, reducing an energy consumption, and operating at a high efficiency.

According to an example embodiment, a blowing unit for an air cleaner and an air cleaner including the same may maximize intake and discharge areas, thereby improving the product efficiency, minimizing a loss of air volume, and reducing noise.

According to an example embodiment, a blowing unit for an air cleaner and an air cleaner including the same may smoothly circulate an air flow of an indoor space and take in or purify contaminated air in a predetermined space in a relatively short time when compared to a single-out type air cleaner.

According to an example embodiment, a blowing unit for an air cleaner and an air cleaner including the same may form a three-dimensional air flow, thereby improving an air circulation rate by about 30%.

According to an example embodiment, a blowing unit for an air cleaner and an air cleaner including the same may be provided in a structure that may be easily assembled and disassembled, thereby improving the manufacturing convenience and facilitating the maintenance.

### BRIEF DESCRIPTION OF THE DRAWINGS

FIG. 1 is a perspective view illustrating a blowing unit for an air cleaner according to an example embodiment.

FIG. 2 illustrates FIG. 1 with a first casing removed.

FIG. 3 illustrates FIG. 1 with a second casing removed.

FIG. 4 is a right-side view of a blowing unit for an air cleaner according to an example embodiment.

FIG. 5 is a cross-sectional view taken along A-A in FIG. 4.

FIG. 6 illustrates an example of a discharge flow rate adjusting member.

FIG. 7 illustrates another example of a discharge flow rate adjusting member.

FIG. 8 illustrates an air cleaner according to an example embodiment.

FIG. 9 is a top view of FIG. 8.

FIG. 10 illustrates a side view of FIG. 8.

FIG. 11 illustrates an example of taking air in an air cleaner according to an example embodiment.

FIG. 12 illustrates an example of discharging air from an air cleaner according to an example embodiment.

### DETAILED DESCRIPTIONS

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

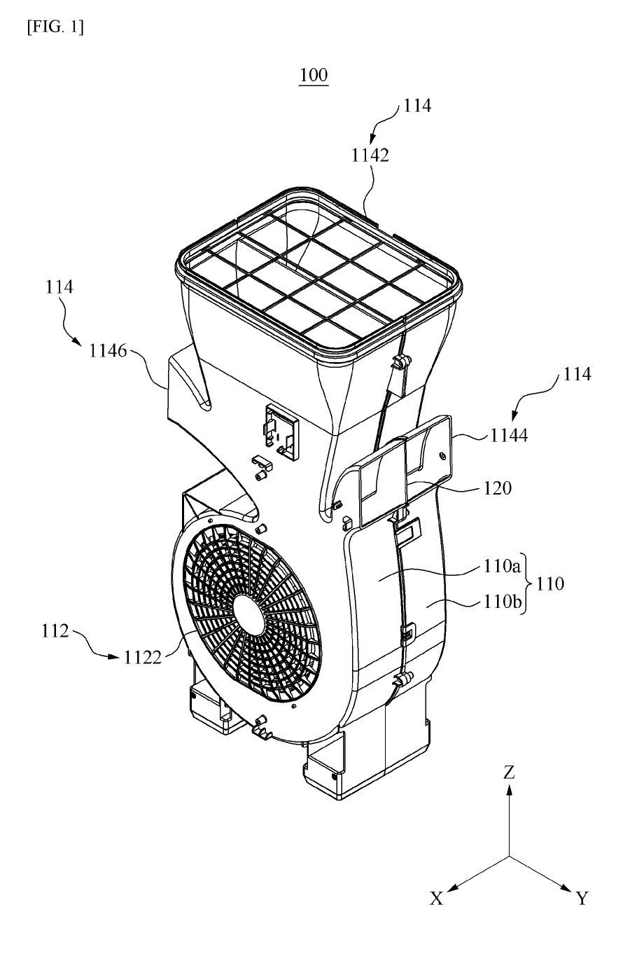

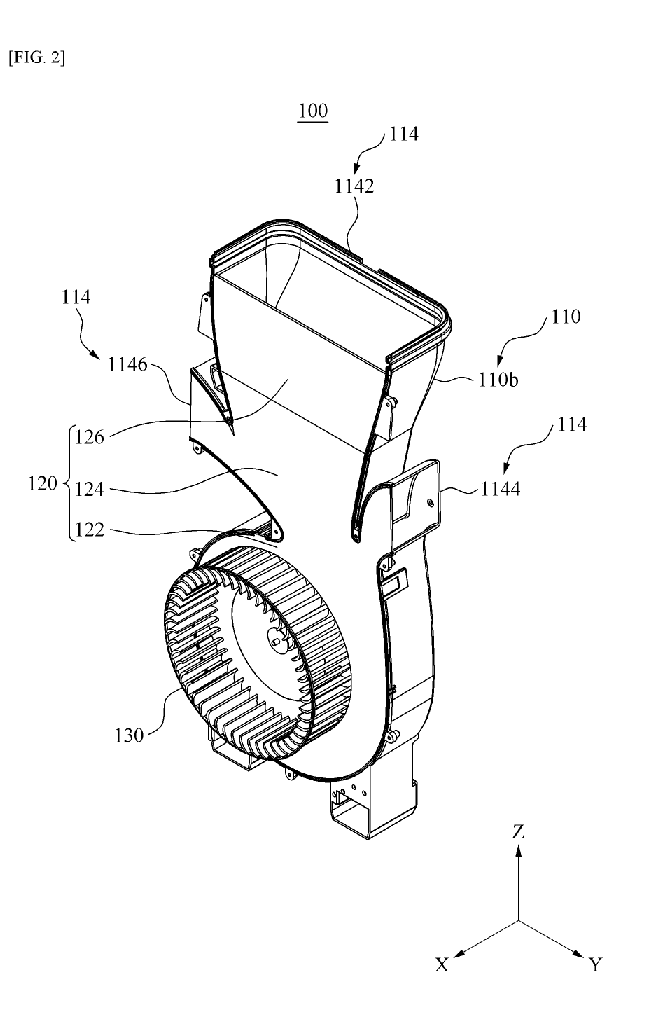

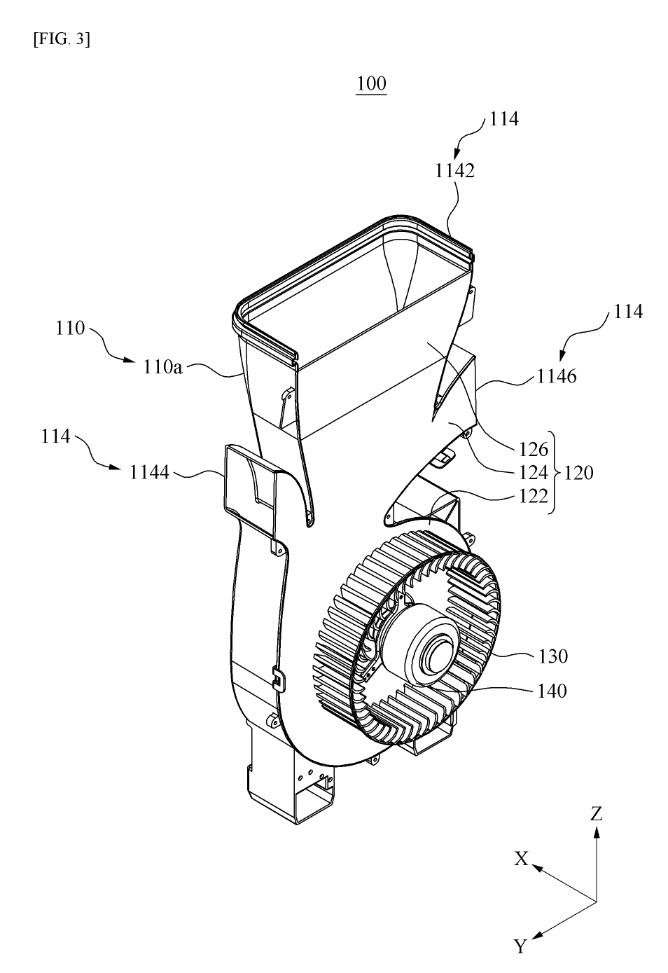

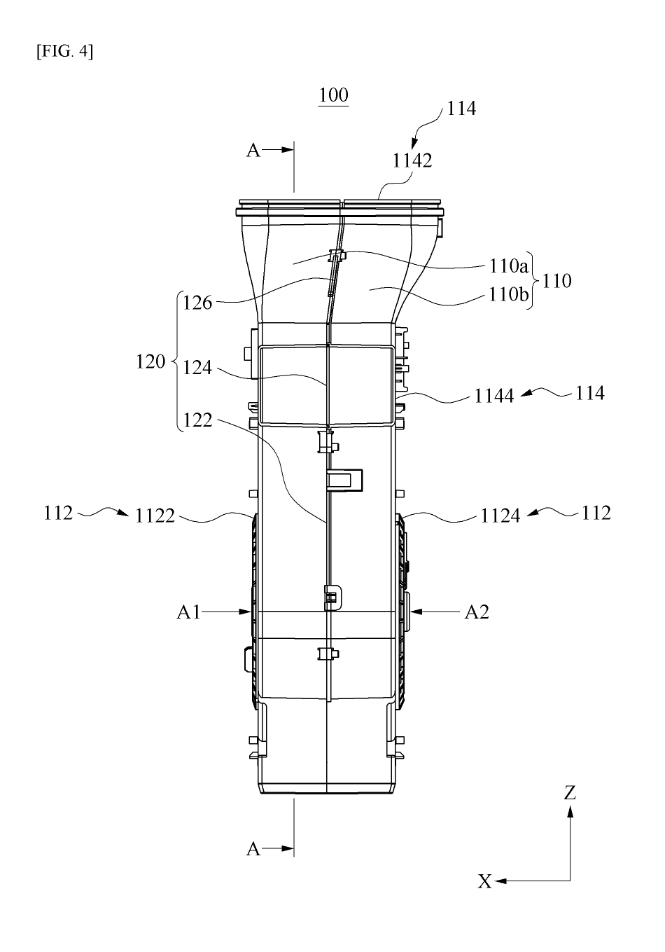

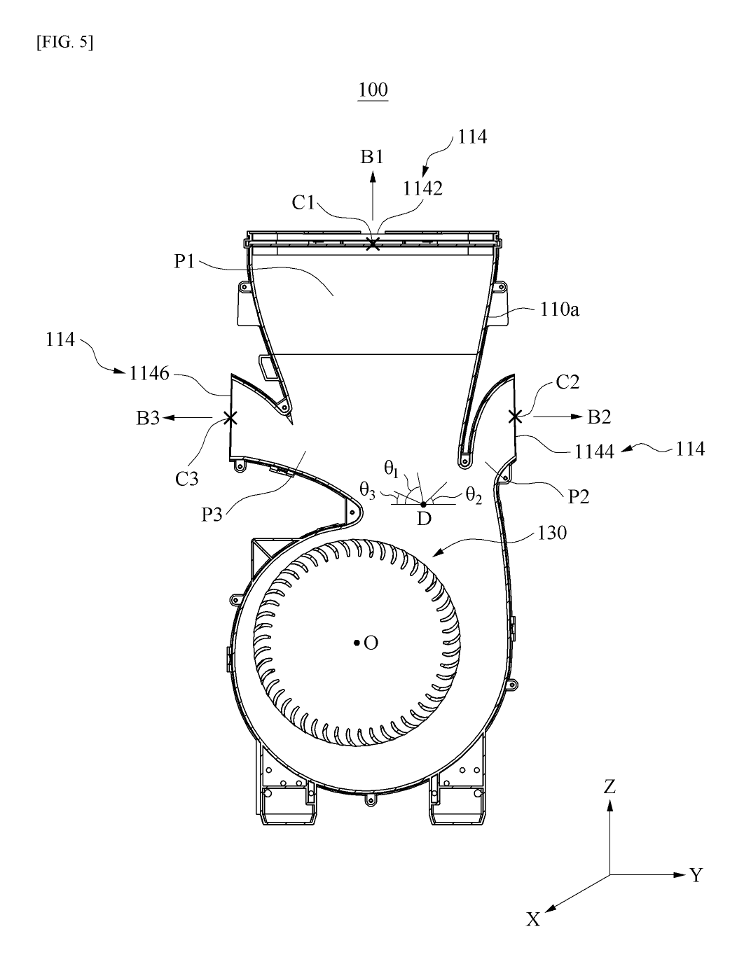

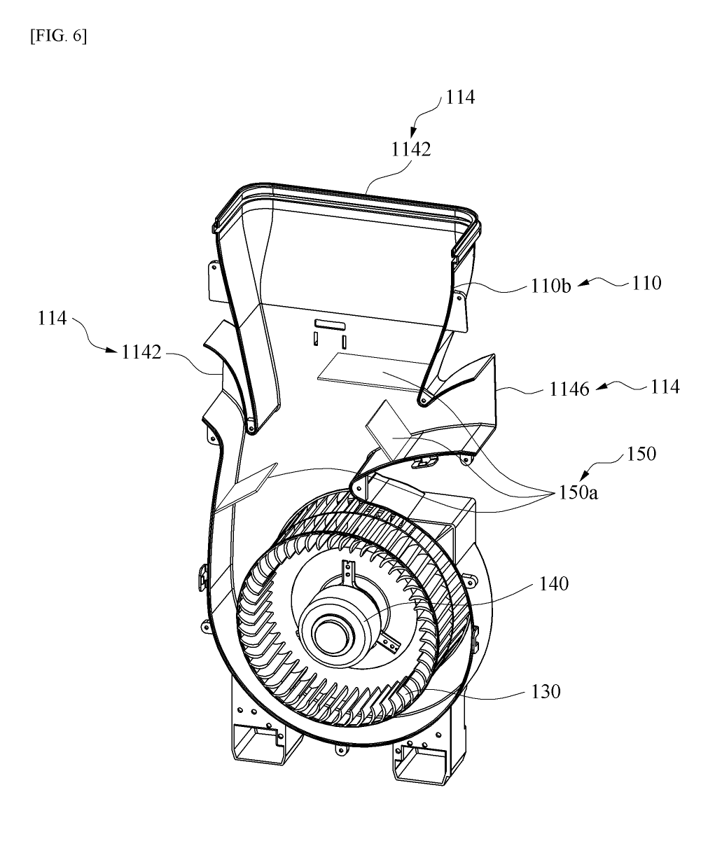

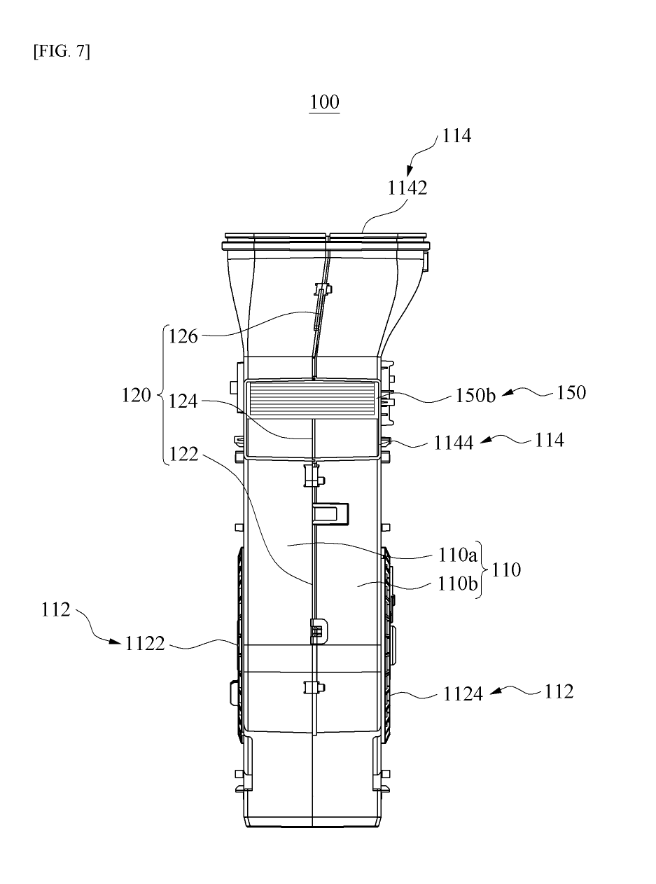

FIG. 1 is a perspective view illustrating a blowing unit for an air cleaner according to an example embodiment, FIG. 2 illustrates FIG. 1 with a first casing removed, FIG. 3 illustrates FIG. 1 with a second casing removed, FIG. 4 is a right-side view of the blowing unit for an air cleaner according to an example embodiment, FIG. 5 is a cross-sectional view taken along A-A in FIG. 4, FIG. 6 illustrates an example of a discharge flow rate adjusting member, and FIG. 7 illustrates another example of the discharge flow rate adjusting member.

Referring to FIGS. 1 through 3, a blowing unit 100 for an air cleaner may include a casing member 110, a separation member 120, a fan member 130 and a driving member 140.

First, hereinafter, a +X-axial direction indicates a direction toward a front of an air cleaner or the casing member 110, a −X-axial direction indicates a direction toward a rear of an air cleaner or the casing member 110, a +Y-axial direction indicates a direction toward a right side of an air cleaner or the casing member 110, a −Y-axial direction indicates a direction toward a left side of an air cleaner or the casing member 110, and a +Z-axial direction indicates a height direction of an air cleaner or the casing member 110.

The casing member 110 may be provided, for example, in a shape of a scroll. The fan member 130 may be rotatably disposed in a portion of the casing member 110, and a blowing path configured to discharge the air taken in by the fan member 130 may be formed in a remaining portion of the casing member 110.

Further, the casing member 110 may include a pair of symmetric casings, for example, a first casing 110a and a second casing 110b, and the first casing 110a and the second casing 110b may be coupled to or separated from each other.

In detail, the first casing 110a may be a half of the casing member 110 that forms the front of the casing member 110, and a rear of the first casing 110a may be opened. Similarly, the second casing 110b may be a remaining half of the casing member 110 that forms the rear of the casing member 110, and a front of the second casing 110b may be opened.

In this example, when the first casing 110a and the second casing 110b are coupled to each other, the separation member 120 may be disposed at a center of the casing member 110. That is, one side of the separation member 120 may become the rear of the first casing 110a, and the other side of the separation member 120 may become the front of the second casing 110b.

Further, a plurality of inlets 112 and a plurality of outlets 114 may be provided in the casing member 110.

The plurality of inlets 112 may include a first inlet 1122 and a second inlet 1124 through which air is taken in from both sides of an axial direction of the fan member 130.

In this example, the axial direction of the fan member 130 may extend along an axis X. The first inlet 1122 may be provided in a side that faces the X-axial direction in the casing member 110 or the front of the casing member 110, and the second inlet 1124 may be provided in a side that faces the −X-axial direction in the casing member 110 or the rear of the casing member 110.

In particular, referring to FIG. 4, a first intake direction A1 of the air through the first inlet 1122 may become the −X-axial direction, and a second intake direction A2 of the air through the second inlet 1124 may become the +X-axial direction.

By providing the plurality of inlets 112 in the casing member 110 as described above, external air may be taken in the casing member 110 through two different sides, for example, the front and the rear, of the casing member 110 when the fan member 130 operates.

However, when the separation member 120 is disposed in the casing member 110 as described above, the air taken in through the first inlet 1122 may be prevented from being guided to the second inlet 1124 or the air taken in through the second inlet 1124 may be prevented from being guided to the first inlet 1122, and the air taken in through the first inlet 1122 and the second inlet 1124 may be discharged to an outside through the plurality of outlets 114.

The plurality of outlets 114 may be formed in the casing member 110 such that the air taken in through the first inlet 1122 and the second inlet 1124 may be discharged in a plurality of directions.

In detail, the plurality of outlets 114 may include a first outlet 1142, a second outlet 1144 and a third outlet 1146.

The first outlet 1142 may discharge the air toward an upper side of the fan member 130, for example, in the +Z-axial direction, and the second outlet 1144 and the third outlet 1146 may discharge the air in a direction perpendicular to the axial direction of the fan member 130, for example, the ±Y-axial direction.

In this example, the second outlet 1144 and the third outlet 1146 may be disposed to face each other. Hereinafter, a case in which the second outlet 1144 discharges the air in the +Y-axial direction, and the third outlet 1146 discharges the air in the −Y-axial direction will be described.

As described above, the first outlet 1142, the second outlet 1144 and the third outlet 1146 may discharge the air in different directions or through three different sides from an upper portion of the fan member 130.

In this example, a cross-sectional area of the second outlet 1144 may be equal to a cross-sectional area of the third outlet 1146, and a cross-sectional area of the first outlet 1142 may be greater than the cross-sectional areas of the second outlet 1144 and the third outlet 1146. Thus, basically a discharge flow rate through the first outlet 1142 may be greater than a discharge flow rate through the second outlet 1144 and a discharge flow rate through the third outlet 1146.

In detail, referring to FIG. 5, a first discharge direction B1 of the air through the first outlet 1142 may be the +Z-axial direction, and a second discharge direction B2 of the air through the second outlet 1144 may be the +Y-axial direction. Thus, the first discharge direction B1 of the air through the first outlet 1142 and the second discharge direction B2 of the air through the second outlet 1144 may be orthogonal to each other.

Similarly, the first discharge direction B1 of the air through the first outlet 1142 may be the +Z-axial direction, and a third discharge direction B3 of the air through the third outlet 1146 may be the −Y-axial direction. Thus, the first discharge direction B1 of the air through the first outlet 1142 and the third discharge direction B3 of the air through the third outlet 1146 may be orthogonal to each other.

Further, the first discharge direction B1 of the air through the first outlet 1142 may be the +Z-axial direction, the second discharge direction B2 of the air through the second outlet 1144 may be the +Y-axial direction, the third discharge direction B3 of the air through the third outlet 1146 may be the −Y-axial direction, and the first intake direction A1 of the air through the first inlet 1122 and the intake direction of the air through the second inlet 1124 may be the ±X-axial direction. Thus, the plurality of discharge directions B1, B2 and B3 through the plurality of outlets 114 may be orthogonal to the plurality of intake directions A1 and A2 through the plurality of inlets 112.

Meanwhile, the casing member 110 may be formed to be branched toward the first outlet 1142, the second outlet 1144 and the third outlet 1146 at an upper portion of one side of the fan member 130.

In detail, a plurality of blowing paths may be formed in the casing member 110 from the upper portion of the one side of the fan member 130.

In this example, the plurality of blowing paths may include a first blowing path P1 extending from the upper portion of the one side of the fan member 130 toward the first outlet 1142, a second blowing path P2 extending from the upper portion of the one side of the fan member 130 toward the second outlet 1144, and a third blowing path P3 extending from the upper portion of the one side of the fan member 130 toward the third outlet 1146.

The first blowing path P1 may be formed to extend from a virtual branch point D toward the first outlet 1142, the virtual branch point D being a point positioned eccentrically on an upper right side from a center O of the fan member 130.

The second blowing path P2 may be formed to extend from the virtual branch point D toward the second outlet 1144, the virtual branch point D being the point positioned eccentrically on the upper right side from the center O of the fan member 130.

The third blowing path P3 may be formed to extend from the virtual branch point D toward the third outlet 1146, the virtual branch point D being the point positioned eccentrically on the upper right side from the center O of the fan member 130.

In particular, a length of the first blowing path P1, a length of the second blowing path P2, and a length of the third blowing path P3 may be different from each other, and the length of the first blowing path P1 may be greater than the length of the second blowing path P2 and the length of the third blowing path P3.

In this example, the length of the first blowing path P1 may be, for example, a length of a straight path or a curved path between the virtual branch point D and a center C1 of the first outlet 1142, the length of the second blowing path P2 may be, for example, a length of a straight path or a curved path between the virtual branch point D and a center C2 of the second outlet 1144, and the length of the third blowing path P3 may be, for example, a length of a straight path or a curved path between the virtual branch point D and a center C3 of the third outlet 1146.

For example, a ratio of the length of the second blowing path P2 to the length of the third blowing path P3 may be in a range of 1:1.5 to 1:2.5, for example, 1:2, and a ratio of the length of the second blowing path P2 to the length of the first blowing path P1 may be in a range of 1:2 to 1:3.

Further, an angle of inclination θ1 of the first blowing path P1, an angle of inclination θ2 of the second blowing path P2, and an angle of inclination θ3 of the third blowing path P3 may be different from each other, and the angle of inclination θ1 of the first blowing path P1 may be greater than the angle of inclination θ2 of the second blowing path P2 and the angle of inclination θ3 of the third blowing path P3.

In this example, the angle of inclination θ1 of the first blowing path P1 may be an angle of inclination of the straight path between the virtual branch point D and the center C1 of the first outlet 1142, the angle of inclination θ2 of the second blowing path P2 may be an angle of inclination of the straight path between the virtual branch point D and the center C2 of the second outlet 1144, and the angle of inclination θ3 of the third blowing path P3 may be an angle of inclination of the straight path between the virtual branch point D and the center C3 of the third outlet 1146.

As described above, the plurality of blowing paths P1, P2 and P3 may be provided in a structure effective in reducing noise while effectively guiding the air taken in from the first inlet 1122 and the second inlet 1124 to the first outlet 1142, the second outlet 1144 and the third outlet 1146.

The separation member 120 may be disposed in the casing member 110.

The separation member 120 may be provided in a shape corresponding to a shape of a central cross-section of the casing member 110.

In detail, the separation member 120 may include a first separating portion 122 that penetrates through a center of the fan member 130 in the Z-axial direction, a second separating portion 124 that penetrates through centers of the plurality of blowing paths P1, P2 and P3 in the Z-axial direction, and a third separating portion 126 that penetrates through the center of the first blowing path P1 among the plurality of blowing paths P1, P2 and P3 in the Z-axial direction.

The first separating portion 122 may penetrate through the center of the fan member 130 in the Z-axial direction, thereby dividing an inner space of the casing member 110 into a plurality of symmetric spaces. By doing so, a half of the fan member 130 may be disposed in the first casing 110a, and a remaining half of the fan member 130 may be disposed in the second casing 110b.

Further, the air taken in through the first inlet 1122 may be blocked not to be guided to the second inlet 1124, or the air taken in through the second inlet 1124 may be blocked not to be guided to the first inlet 1122.

In addition, the first separating portion 122 may fix the fan member 130 and the driving member 140 in the casing member 110.

The second separating portion 124 may be connected to an upper end of the first separating portion 122 and penetrate through the centers of the plurality of blowing paths P1, P2 and P3 in the Z-axial direction. By doing so, the plurality of blowing paths P1, P2 and P3 near the virtual branch point D may be divided into the plurality of symmetric paths.

In this example, the second separating portion 124 may also penetrate through the centers of the first outlet 1142, the second outlet 1144 and the third outlet 1146, thereby dividing the first outlet 1142, the second outlet 1144 and the third outlet 1146.

In particular, the center C2 of the second outlet 1144 may be positioned on a right end of the second separating portion 124, and the center C3 of the third outlet 1146 may be positioned on a left end of the second separating portion 124.

However, the upper end of the second separating portion 124 may be positioned higher than the second outlet 1144 and the third outlet 1146 and lower than the first outlet 1142, and thus the center C1 of the first outlet 1142 may not be positioned at an upper end of the second separating portion 124.

The third separating portion 126 may be connected to the upper end of the second separating portion 124 and penetrate through the center of the first blowing path P1 among the plurality of blowing paths P1, P2 and P3 in the Z-axial direction. In this example, the center of the first outlet 1142 may be positioned at an upper end of the third separating portion 126 such that the first blowing path P1 may be divided into a plurality of symmetric paths.

In conclusion, the second blowing path P2 and the third blowing path P3 may be divided by the second separating portion 124. However, a portion of the lower side of the first blowing path P1 may be divided by the second separating portion 124 and a portion of the upper side of the first blowing path P1 may be divided by the third separating portion 126.

In this example, by the shape of the first blowing path P1, the third separating portion 126 may be connected to be bent with respect to the second separating portion 124. Conversely, the first separating portion 122 and the second separating portion 124 may be connected flat.

As described above, by the separation member 120, a half of the first blowing path P1, the second blowing path P2 and the third blowing path P3 and a half of the first outlet 1142, the second outlet 1144 and the third outlet 1146 may be provided in the first casing 110a, and a remaining half of the first blowing path P1, the second blowing path P2 and the third blowing path P3 and a remaining half of the first outlet 1142, the second outlet 1144 and the third outlet 1146 may be provided in the second casing 110b.

Thus, the air taken in through the first inlet 1122 provided in the first casing 110a may be discharged toward a top and both sides of the casing member 110 through the half of the first outlet 1142, the second outlet 1144 and the third outlet 1146 provided in the first casing 110a, and the air taken in through the second inlet 1124 provided in the second casing 110b may be discharged toward the top and both sides of the casing member 110 through the half of the first outlet 1142, the second outlet 1144 and the third outlet 1146 provided in the second casing 110b.

Meanwhile, referring to FIGS. 1 through 4 again, the fan member 130 may be received in the casing member 110 while being mounted on the separation member 120.

The fan member 130 may be a 2-way-in type in which both sides of the axial direction are opened such that air may be taken in from both the sides.

For example, the fan member 130 may be provided as a 2-way-in centrifugal type or compound leaf type in which air may be taken in from both sides of the axial direction and discharged in a circumferential direction.

In detail, one of both sides of the axial direction of the fan member 13 may be exposed on a front of the casing member 110 through the first inlet 1122, and the other one of both side of the fan member 130 may be exposed on a rear of the casing member 110 through the second inlet 1124.

Further, the half of the fan member 130 may be disposed in the first casing 110a by the separation member 120, thereby guiding the air taken in through the first inlet 1122 along the first blowing path P1, the second blowing path P2 and the third blowing path P3 disposed in the first casing 110a to the first outlet 1142, the second outlet 1144 and the third outlet 1146.

Similarly, the remaining half of the fan member 130 may be disposed in the second casing 110b by the separation member 120, thereby guiding the air taken in through the second inlet 1124 along the first blowing path P1, the second blowing path P2 and the third blowing path P3 disposed in the second casing 110b to the first outlet 1142, the second outlet 1144 and the third outlet 1146.

Meanwhile, the driving member 140 may be provided, for example, as a motor, and may be fixed particularly to the separation member 120 as shown in FIG. 3.

That is, a driving shaft of the driving member 140 may penetrate through the separation member 120 and be connected to the center O of the fan member 130, and the driving member 140 may be received in the fan member 130 within any one of the first casing 110a and the second casing 110b.

By the driving member 140 disposed as described above, the fan member 130 may be driven to rotate in the casing member 110.

Meanwhile, particularly referring to FIGS. 6 and 7, a discharge flow rate adjusting member 150 may be provided in the casing member 110.

The discharge flow rate adjusting member 150 may separately adjust air flow rates on the first blowing path P1, the second blowing path P2 and the third blowing path P3, or cross-sectional areas of the first outlet 1142, the second outlet 1144 and the third outlet 1146.

As shown in FIG. 6, the discharge flow rate adjusting member 150 may be provided in a form of a baffle, and a plurality of baffles 150a may be disposed on the first blowing path P1, the second blowing path P2 and the third blowing path P3 to adjust the air flow rates to be guided to the first blowing path P 1, the second blowing path P2 and the third blowing path P3, thereby separately adjusting discharge flow rates through the first outlet 1142, the second outlet 1144 and the third outlet 1146.

Further, as shown in FIG. 7, the discharge flow rate adjusting member 150 may be provided in a form of a shutter, and a plurality of shutters 150b may be provided in the first outlet 1142, the second outlet 1144 and the third outlet 1146 to separately adjust the discharge flow rates through the first outlet 1142, the second outlet 1144 and the third outlet 1146.

However, the configuration or the arrangement of the discharge flow rate adjusting member 150 is not limited thereto, and any configuration or arrangement that may effectively adjust the discharge flow rates through the first outlet 1142, the second outlet 1144 and the third outlet 1146 may be applicable thereto.

Furthermore, although not shown in detail, it is obvious that an intake flow rate adjusting member may be provided in the casing member 110 to separately adjust intake flow rates through the first inlet 1122 and the second inlet 1124.

As described above, the blowing unit for an air cleaner may maximize intake and discharge areas, thereby improving the product efficiency, minimizing a loss of air volume, and reducing noise. Further, the blowing unit for an air cleaner may be provided in a structure that may be easily assembled or disassembled, thereby improving the manufacturing convenience and facilitating the maintenance.

The blowing unit for an air cleaner has been described above. Hereinafter, an air cleaner including the same will be described.

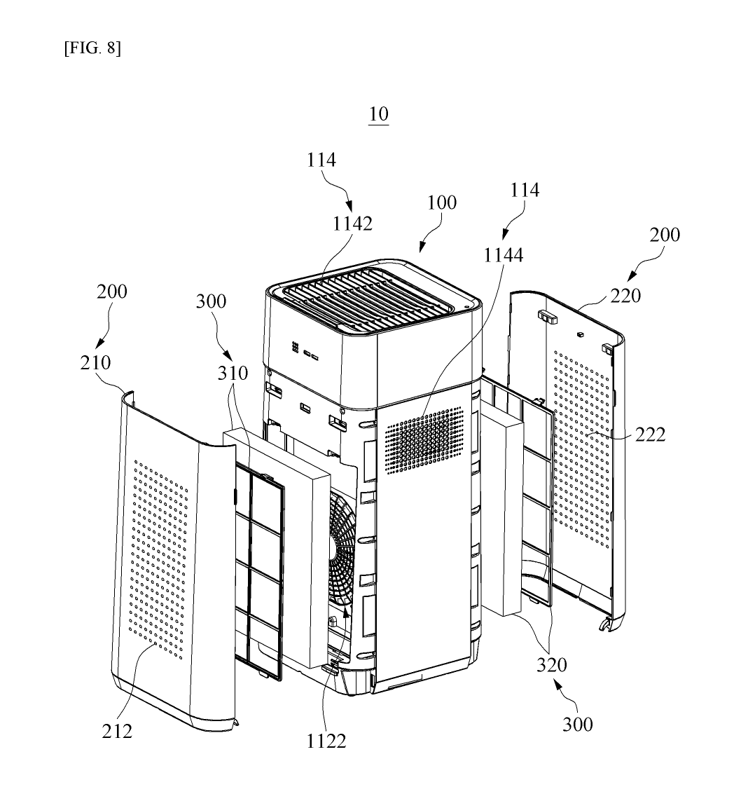

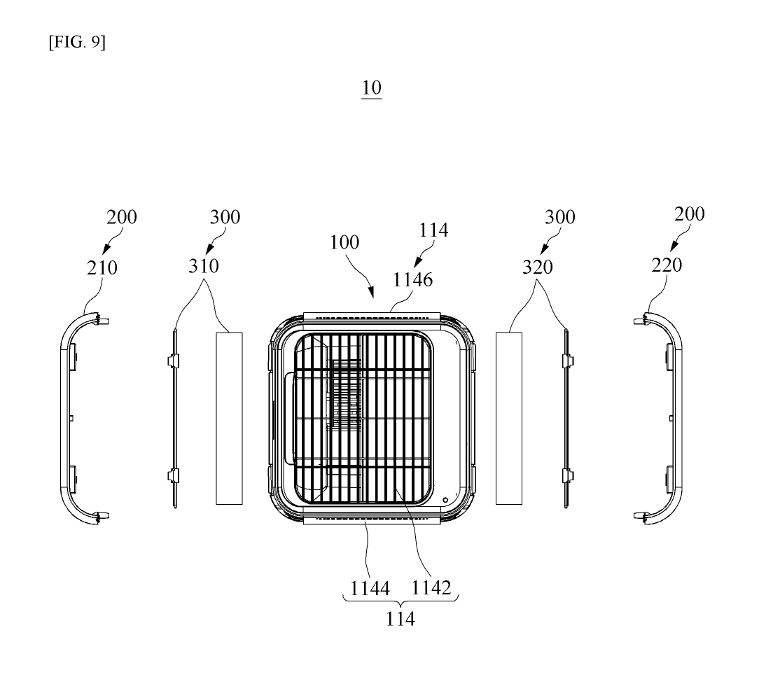

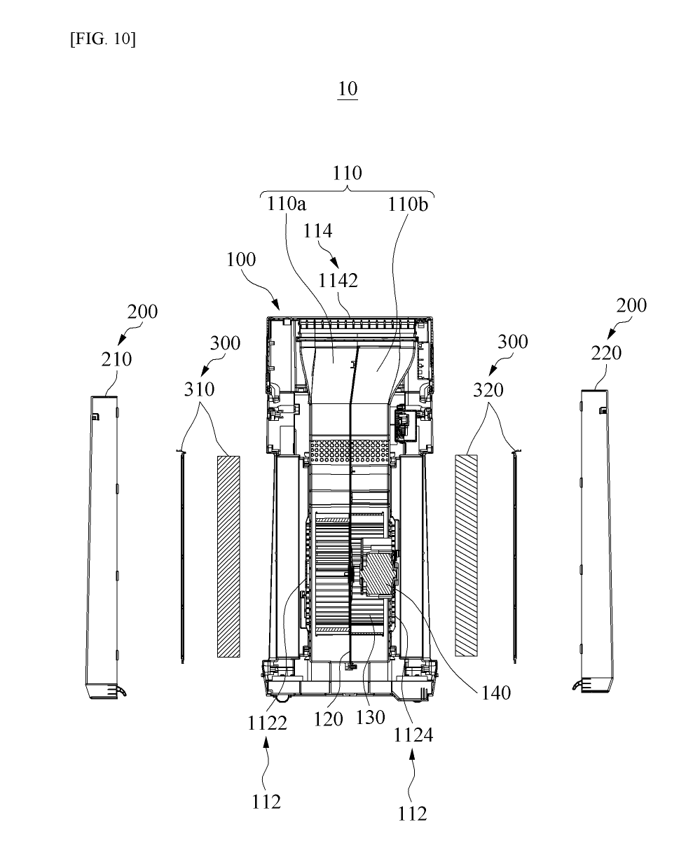

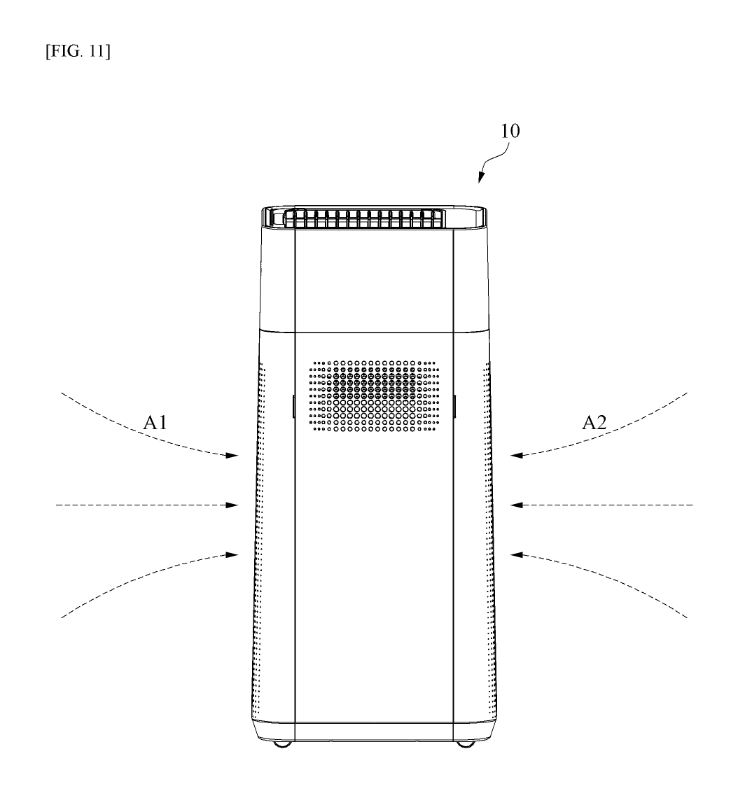

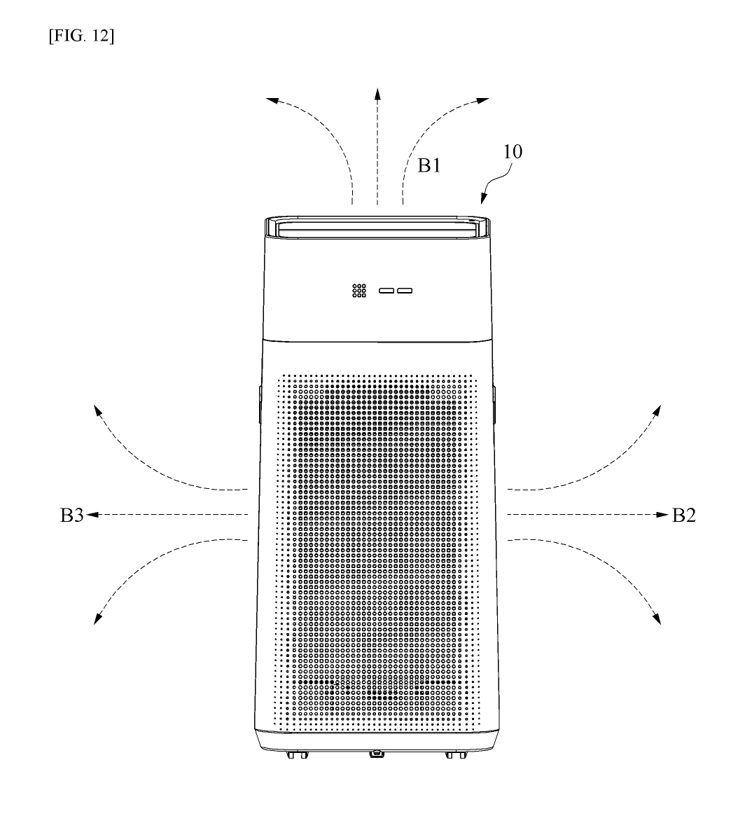

FIG. 8 illustrates an air cleaner according to an example embodiment, FIG. 9 is a top view of FIG. 8, FIG. 10 illustrates a side view of FIG. 8, FIG. 11 illustrates an example of taking air in the air cleaner according to an example embodiment, and FIG. 12 illustrates an example of discharging air from the air cleaner according to an example embodiment.

Referring to FIGS. 8 through 10, an air cleaner 10 may include the blowing unit 100, a cover unit 200, and a filter unit 300.

The blowing unit may be a configuration corresponding to the blowing unit for an air cleaner described above, and thus the detailed description of the blowing unit will be omitted herein.

The cover unit 200 may be provided to cover a side of the blowing unit 100 in which the plurality of inlets 1122 and 1124 is formed.

In detail, the cover unit 200 may include a first cover 210 to cover a front of the first casing 110a, and a second cover 220 to cover a rear of the second casing 110a. That is, the plurality of plurality of inlets 1122 and 1124 may be disposed toward the front and the rear of the cover unit 200.

In this example, a first intake hole 212 may be formed in the first cover 210 to communicate with the first inlet 1122, and a second intake hole 222 may be formed in the second cover 220 to communicate with the second inlet 1124.

Further, the plurality of outlets 1142, 1144 and 1146 provided in the blowing unit 100 may be exposed to an outside, rather than being closed by the cover unit 200.

In this example, the plurality of outlets 1142, 1144 and 1146 may be disposed toward the top and both sides of the cover unit 200.

Meanwhile, the filter unit 300 may be disposed between the blowing unit 100 and the cover unit 200.

The filter unit 300 may include a first filter 310 disposed between the front of the blowing unit 100 and the first cover 210, and a second filter 320 disposed between the rear of the blowing unit 100 and the second cover 220.

The first filter 310 may purify the air taken in through the first inlet 1122, and the second filter 320 may purify the air taken in through the second inlet 1124.

In this example, the first filter 310 and the second filter 320 may include a plurality of filters, and the plurality of filters may include an air cleaning filter or an additional function filter.

The air cleaning filter may include a combination of a pre-filter that removes relatively large dust, a medium filter that removes dust of medium size, and a high efficiency particulate air (HEPA) filter that removes contaminants of micro sizes such as house dust and mites, and may perform a general air cleaning function.

The additional function filter may include any one or any combination of a humidification filter, a dehumidification filter, a deodorization filter, and an air cleaning filter. However, a type of the additional function filter is not limited thereto, and it is obvious that various types of filters such as a yellow dust filter, a filter for baby, a sick building syndrome (SBS) filter for new building, and an SBS filter for old building may be applied thereto.

In particular, referring to FIGS. 11 and 12 further, when the fan member 130 operates, the air taken from the front of the air cleaner 10 in the first intake direction A1 through the first inlet 1122 may be cleaned through the first filter 310, moved along the plurality of blowing paths formed in the first casing 110a, and discharged through the first outlet 1142, the second outlet 1144 and the third outlet 1146 from the top and both sides of the air cleaner 10 in the first discharge direction B1, the second discharge direction B2 and the third discharge direction B3.

At the same time, when the fan member 130 operates, the air taken from the rear of the air cleaner 10 in the second intake direction A2 through the second inlet 1124 may be cleaned through the second filter 320, moved along the plurality of blowing paths formed in the second casing 110b, and discharged through the first outlet 1142, the second outlet 1144 and the third outlet 1146 from the top and both sides of the air cleaner 10 in the first discharge direction B1, the second discharge direction B2 and the third discharge direction B3.

As described above, the air cleaner may combine 2-way-in and 3-way-out, thereby smoothly circulating an air flow of an indoor space and taking in or purifying contaminated air in a predetermined space in a relatively short time when compared to a single-out type, and form a three-dimensional air flow, thereby improving an air circulation rate by about 30%.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Description of Reference Numerals: 10: Air cleaner, 100: Blowing unit, 110: Casing member, 120: Separation member, 130: Fan member, 140: Driving member, 150: Discharge flow rate adjusting member, 200: Cover unit, 210: First cover, 220: Second cover, 300: Filter unit, 310: First filter, and 320: Second filter.

1. A blowing unit for an air cleaner, the blowing unit comprising:
a fan member configured to take air in from both sides of an axial direction thereof and discharge the air; and
a casing member in which the fan member is rotatably disposed, a plurality of inlets through which the air is taken in from both the sides of the axial direction of the fan member is formed, and a plurality of outlets through which the air is discharged in a plurality of directions is formed,
wherein the plurality of outlets comprises:
a first outlet configured to discharge the air toward an upper side of the fan member; and
a second outlet configured to discharge the air in a direction perpendicular to the axial direction of the fan member.

2. The blowing unit of claim 1, wherein the plurality of outlets further comprises:
a third outlet disposed to face the second outlet in the casing member, the third outlet configured to discharge the air in another direction perpendicular to the axial direction of the fan member,
wherein the first outlet, the second outlet and the third outlet are configured to discharge the air in different directions from an upper portion of the fan member.

3. The blowing unit of claim 1, wherein a first discharge direction of the air through the first outlet is orthogonal to a second discharge direction of the air through the second outlet, and
the first discharge direction of the air through the first outlet and the second discharge direction of the air through the second outlet are orthogonal to an intake direction of the air through a plurality of inlets.

4. The blowing unit of claim 2, wherein the casing member is formed to be branched toward the first outlet, the second outlet and the third outlet at an upper portion of one side of the fan member, and
a plurality of blowing paths is formed in the casing member from the upper portion of the one side of the fan member,
wherein the plurality of blowing paths comprises:
a first blowing path extending from the upper portion of the one side of the fan member toward the first outlet;
a second blowing path extending from the upper portion of the one side of the fan member toward the second outlet; and
a third blowing path extending from the upper portion of the one side of the fan member toward the third outlet.

5. The blowing unit of claim 4, wherein a length of the second blowing path is different from a length of the third blowing path, and a length of the first blowing path is greater than the length of the second blowing path and the length of the third blowing path.

6. The blowing unit of claim 4, wherein an angle of inclination of the first blowing path, an angle of inclination of the second blowing path and an angle of inclination of the third blowing path are different from each other, and
the angle of inclination of the first blowing path is greater than the angle of inclination of the second blowing path and the angle of inclination of the third blowing path.

7. The blowing unit of claim 4, further comprising:
a discharge flow rate adjusting member configured to separately adjust air flow rates of the first blowing path, the second blowing path and the third blowing path or cross-sectional areas of the first outlet, the second outlet and the third outlet.

8. The blowing unit of claim 1, further comprising: a separation member disposed to penetrate through a center of the fan member in the casing member, wherein the casing member is divided into a pair of symmetric casings by the separation member such that blowing paths and the plurality of outlets are divided separately in the casing member.

9. The blowing unit of claim 8, further comprising:
a driving member configured to transmit power to the fan member,
wherein the driving member is inserted into the fan member and fixed to the separation member, and
a half of the fan member is received in one of the plurality of casings and a remaining half of the fan member is received in the other one of the plurality of casings.

10. An air cleaner, comprising:
a blowing unit including a plurality of inlets configured to take air in and a plurality of outlets configured to discharge the air;
a cover unit configured to cover a side in which the plurality of inlets of the blowing unit is formed, the cover unit including an intake hole formed to communicate with the plurality of inlets; and
a filter unit disposed between the blowing unit and the cover unit,
wherein the plurality of inlets is disposed toward a front and a rear of the cover unit, and the plurality of outlets is disposed toward a top and both sides of the cover unit.

11. The air cleaner of claim 10, wherein the blowing unit comprises:
a fan member configured to take air in from both sides of an axial direction thereof and discharge the air radially;
a driving member configured to transmit driving power to the fan member;
a casing member in which the fan member is rotatably disposed and the plurality of inlets and the plurality of outlets are formed; and
a separation member disposed to penetrate through a center of the fan member, the separation member to which the fan member and the driving member are fixed,
wherein passages of the air and the plurality of outlets in the casing member are divided by the separation member.
